(19) United States
(12) Patent Application Publication
(10) Pub. No.: US 2015/0073840 A1
(43) Pub. Date: Mar. 12, 2015

(54) INFORMATION PROCESSING DEVICE, PROGRAM AND ELECTRONIC RECEIPT SYSTEM

(71) Applicant: Toshiba Tec Kabushiki Kaisha, Tokyo (JP)

(72) Inventors: Taro ANDO, Shizuoka (JP); Tsuyoshi GOTANDA, Tokyo (JP); Akiko SUSAKI, Tokyo (JP); Yumiko OKUMA, Tokyo (JP); Maki SATO, Kanagawa (JP); Takuro MASUDA, Tokyo (JP)

(73) Assignee: TOSHIBA TEC KABUSHIKI KAISHA, Tokyo (JP)

(21) Appl. No.: 14/194,550

(22) Filed: Feb. 28, 2014

(30) Foreign Application Priority Data
Sep. 6, 2013 (JP) 2013-185571

(51) Int. Cl. G06Q 20/04

(52) U.S. Cl. CPC G06Q 20/045
USPC 705/5; 705/35

(57) ABSTRACT

According to one embodiment, an information processing device includes a member association unit configured to maintain a code of a consumer, a reception unit configured to receive electronic receipt information and additional information corresponding to the code maintained by the member association unit from an electronic receipt management server, which associates the code of each consumer with the electronic receipt information and other information collected for a plurality of companies, the electronic receipt information including information concerning payments made by the consumer to each of the plurality of companies, and the additional information added to the electronic receipt information, and a display unit configured to display the electronic receipt information and the additional information, which are received by the reception unit.

### CROSS-REFERENCE TO RELATED APPLICATION

This application is based upon and claims the benefit of priority from Japanese Patent Application No. 2013-185571, filed Sep. 6, 2013, and Japanese Patent Application No. 2013-41299, filed Mar. 1, 2013; the entire contents of both applications are incorporated herein by reference.

### FIELD

Embodiments described herein relate to an information processing device, a program and an electronic receipt system.

### BACKGROUND

In the related art, an electronic receipt system is known in which a customer receipt reflecting a purchase of a product or service is provided by a store to a customer upon payment by electronic delivery to a portable terminal or the like of the customer.

By providing the receipt as electronic data, there is a benefit to the consumer in that a household account book, such as a check book, may be automatically kept in electronic form. In addition, since it is possible to reduce the consumption of receipt paper by providing electronic receipts, there is also a benefit to stores which provide electronic receipts.

In addition, it is also known that product sales promotion and advertisement may be performed by electronically by adding additional information, such as coupons relating to a purchased product, to the electronic receipt.

### DESCRIPTION OF THE DRAWINGS

FIG. 1 is a configuration diagram illustrating a configuration of an electronic receipt system according to the embodiment.

FIG. 2 is a block diagram illustrating the configuration of various components of a portable terminal.

FIG. 3 is a block diagram illustrating the configuration of various components of a POS terminal.

FIG. 4 is a block diagram illustrating the configuration of various components of an electronic receipt server.

FIG. 5 is a block diagram illustrating the configuration of various components of an electronic receipt management server.

FIG. 6 is a functional block diagram relating to an electronic receipt process performed in the POS terminal.

FIG. 7 is a flow chart illustrating the flow of the electronic receipt process.

FIG. 8 is a flow chart illustrating the flow of an information transmission process performed in the electronic receipt server.

FIG. 9 is a functional block diagram relating to an electronic receipt management process and a product information transmission process performed in the electronic receipt management server.

FIG. 10 is a flow chart illustrating the flow of the electronic receipt management process and the product information transmission process.

FIG. 11 is a functional block diagram relating to the electronic receipt receiving process and an electronic receipt viewing process performed in the portable terminal.

FIG. 12 is a flow chart illustrating the flow of the electronic receipt receiving process and the electronic receipt viewing process.

FIG. 13 is a front view illustrating a display example of the portable terminal.

FIG. 14 is a flow chart illustrating the flow of the electronic receipt receiving process and the electronic receipt viewing process.

FIG. 15 is a front view illustrating a display transition example of the portable terminal.

FIG. 16 is a flow chart illustrating the flow of a statistical information generation process performed in the portable terminal.

FIG. 17 is a flow chart illustrating the flow of the electronic receipt receiving process and an additional information viewing process according to the embodiment.

FIG. 18 is a front view illustrating a display example of the portable terminal.

FIG. 19 is a front view illustrating a display example of the portable terminal.

FIG. 20 is a flow chart illustrating the flow of the electronic receipt receiving process and the additional information viewing process according to a modification example.

FIG. 21 is a front view illustrating a display example of the portable terminal.

FIG. 22 is a front view illustrating a display example of the portable terminal.

FIG. 23 is a front view illustrating a display example of the portable terminal.

FIG. 24 is a front view illustrating a display example of the portable terminal.

FIG. 25 is a front view illustrating a display example of the portable terminal.

### DETAILED DESCRIPTION

The consumer benefit of the electronic receipt system of the related art is limited to a specific company which has introduced the electronic receipt system, where the company is the seller of the product or the service. Therefore, a user of the electronic receipt system may receive the benefits of the electronic receipts separately from each different company which offers electronic receipts. In addition, since each different company may have different user requirements, different registration requirements, and different protocol for interfacing with that company's electronic receipt system, these systems become difficult for the consumer to use, and to track the receipt information received therefrom. In addition, the consumer must also deal with paper receipts when using a store of a company which has not yet introduced an electronic receipt system. Therefore, it is desirable to promote the introduction of the electronic receipts.

In general, according to one embodiment, there is provided an information processing device including a member association unit configured to maintain a code of a consumer, a reception unit configured to receive electronic receipt information and additional information corresponding to the code maintained by the member association unit from an electronic receipt management server, which associates the code of each consumer with the electronic receipt information and other information collected for a plurality of companies, the electronic receipt information including information concerning payments made by the consumer to each of the plurality of companies, and the additional information added to the electronic receipt information, and a display unit configured to display the electronic receipt information and the additional information, which are received by the reception unit.

As an application example of the electronic receipt system, it is possible to send additional information such as coupons, which are used to lower the monetary amount paid by a consumer for products and the like, as well as lottery tickets for prize draws which the seller (the company) of the product organizes, by adding the additional information to the electronic receipt. It is possible to manage all of the additional information using electronic receipt application software. In the application software, it is possible to display any coupons receiver from a company in a list, to select a coupon from the list and display the coupon, and the like.

Hereinafter, description will be given of an embodiment on the basis of the drawings.

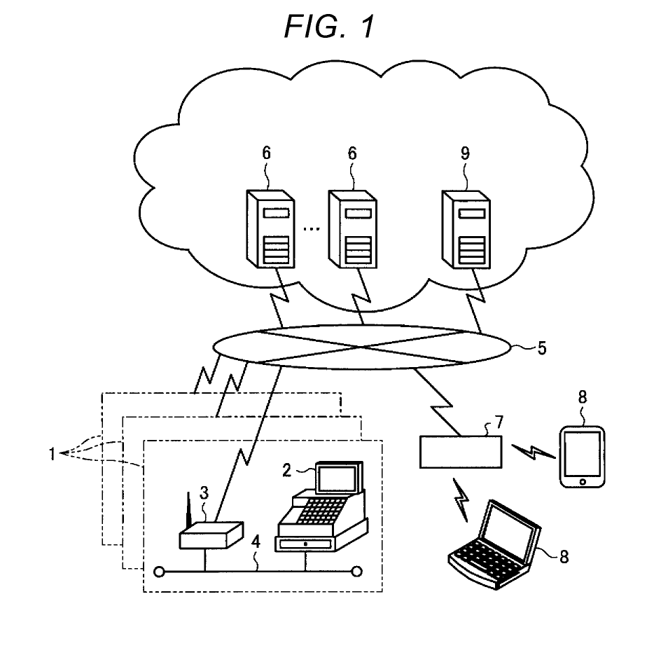

FIG. 1 is a configuration diagram showing the overall configuration of an electronic receipt system according to the embodiment. As shown in FIG. 1, a point of sales (POS) terminal 2 (only one is shown in FIG. 1, however, there may also be a plurality), which is a product sales data processing device which executes product sales data processing, and a router 3 are installed in a store 1. The POS terminal 2 and the router 3 are connected using an in-store Local Area Network (LAN) 4. The router 3 is a device for connecting the in-store LAN 4 to the Internet or a network 5, which is a virtual private network (VPN). Furthermore, while not particularly shown in the drawings, the store 1 may also be provided with a store server, which controls the POS terminal 2.

An electronic receipt server 6 is connected to the network 5. A plurality of electronic receipt servers 6 are provided to manage electronic receipt and other related information for each company which sells products or services and has a physical store or a chain store (hereinafter referred to as a store) such as a convenience store, a supermarket, a foodstuff vendor, a drugstore, an apparel vendor, a home electronic appliances vendor, a department store, a household goods store or a catering establishment that is a member of the electronic receipt system. The electronic receipt server 6 functions as a corporate receipt management server, which stores and manages electronic receipt information by each company code, the code indicating the company that administers the store. Furthermore, the electronic receipt server 6 may also be configured to interface with a head office server of a POS system, which includes functions such as sales management, sales analysis and stock management of each company which administers a store.

In addition, a portable terminal 8 is connected to the network 5 via a base station 7, which performs wireless communication according to a standard such as wireless fidelity (Wi-Fi). The portable terminal 8 is an information processing device, which implements a web browser, such as a smart phone, a mobile telephone, a personal digital assistant (PDA) or a tablet computer, for example. Furthermore, instead of the portable terminal 8, an information processing device such as a personal computer such as a notepad PC may also be used.

Furthermore, an electronic receipt management server 9, which functions as a customer receipt management server that collectively stores and manages the electronic receipt information of various companies that maintain stores is also connected to the network 5. A consumer who is pre-registered as a member in order to receive electronic receipt service may obtain electronic receipt information from the electronic receipt management server 9 using the portable terminal 8, via the network 5. The electronic receipt management server 9, for example, is managed by a third party organization other than the company which manages the electronic receipt information using the electronic receipt server 6. Furthermore, the electronic receipt server 6 may also be managed by a third party organization or the like. In addition, the functions of the electronic receipt server 6 may also be provided on the electronic receipt management server 9 and managed using one server. In addition, a function in which the electronic receipt information for each company, which indicates the company that owns or manages a store, is managed collectively using a plurality of company codes may also be provided as a service (an application) in the form of software as a service (SaaS), which is a type of cloud computing, for example.

Furthermore, member registration by a consumer to enable the consumer to receive electronic receipts from the electronic receipt service is performed in the following manner. The consumer transmits an empty, i.e., blank email from the portable terminal 8 to a member management server via the network 5. The member management server transmits a uniform resource locator (URL), which indicates a page for performing member registration, to the email address of the received email. The consumer accesses the URL of the page for performing member registration from the portable terminal 8, causes the portable terminal 8 to display the input screen of the registration page and inputs the necessary items thereinto to obtain member registration. An input confirmation screen is displayed on the portable terminal 8 after the consumer completes the input of the necessary items. Furthermore, after the consumer confirms the input, the member registration is executed in relation to a member master list. Subsequently, the member management server distributes a member registration completed mail, which includes a member code and a password, to the portable terminal 8. Accordingly, the member registration is completed. Furthermore, after the completion of the registration, a “top screen display” button is provided on the registration complete screen, which is displayed on the portable terminal 8. By operating the “top screen display” button, the portable terminal 8 displays the top screen.

In the electronic receipt system configured as described above, the electronic receipt information that shows payment information, which is generated by performing product sales data processing using the POS terminal 2 of the store 1, is transmitted to the electronic receipt management server 9 via the electronic receipt server 6 via the network 5. The electronic receipt information is transmitted from the electronic receipt management server 9 to the portable terminal 8 of a member. The member causes the display unit of the portable terminal 8 to display the electronic receipt information, and may confirm the content thereof. In addition, the electronic receipt management server 9 publishes the electronic receipt information on the web. The portable terminal 8, which implements a web browser, by specifying a uniform resource locator (URL), may download the electronic receipt information, which is published on the web, to the portable terminal 8 and view the electronic receipt information using the web browser. Furthermore, a configuration may also be adopted in which application software for viewing the electronic receipt information is installed on the portable terminal 8 and the electronic receipt information is viewed using the application software.

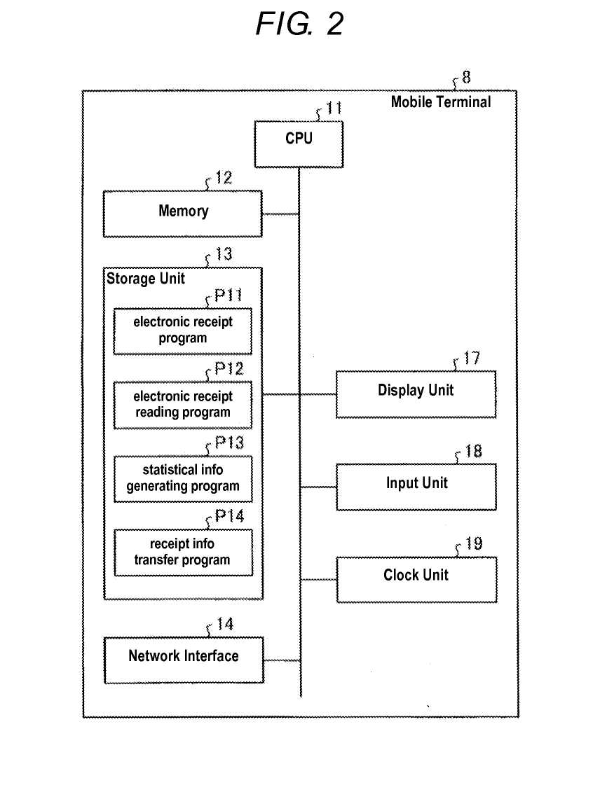

The portable terminal 8 stores the member code and password, which the consumer acquires in the manner described above, in a storage unit 13 (refer to FIG. 2). As the output method of the member code, which is stored in this manner, display by bar-code, display by two-dimensional code, transmission by information communication using near field communication (NFC), which is near field wireless communication, and the like may be used.

Furthermore, association between the member code, which is acquired in order for the consumer to receive the electronic receipt service, and an existing company member card of a point service or the like, i.e., a customer loyalty program, which is administered by a company such as a chain store or the like, may be realized using the POS terminal 2 of each retail store or the portable terminal 8 of each individual person.

Here, description will be given of an operation example of establishing a relationship between the member code, which is acquired by the consumer as described above, and the existing company member card.

### 1. Operation Example in POS Terminal 2 of Store

(1) First, a checker, who operates the POS terminal 2, confirms whether or not to provide the electronic receipt service during a consumer's purchase of a product (payment), and confirms the presence of a point card. When the electronic receipt service is to be carried out, the consumer presents the portable terminal 8 and the point card.

(2) The checker reads the member code stored in the portable terminal 8 and the company member code of the point card, respectively. Here, the reading of the member code stored in the portable terminal 8 depends on an input-output provided in the POS terminal 2. For example, when the POS terminal 2 is provided with a code reader that reads code symbols, the member code, which is held in a bar-code or a two-dimensional code, is read. In addition, when the POS terminal 2 is provided with a short range wireless device, which conforms to NFC or the like, the member code, which is held in an IC tag or the like, is read.

(3) The POS terminal 2 transmits a transaction, the member code read in (2) and the company member code of the point card to the electronic receipt management server 9.

(4) The electronic receipt management server 9 receives the information transmitted in (3), and registers the electronic receipt information indicating a payment amount, which is generated by performing product sales data processing using the POS terminal 2 of the store 1, and the member code to the electronic receipt management server 9. In addition, when the company member code of the point card is transmitted for the first time at the same time as the electronic receipt information and the member code, the company member code is also registered to the electronic receipt management server 9.

Hereinafter, the consumer may receive the service of the electronic receipt system and the point addition service by presenting only the portable terminal 8 or the point card.

### 2. Operation Example in Portable Terminal 8

(1) First, the consumer logs into a point card registration menu by accessing a specific URL from the portable terminal 8, which the consumer owns, or by using an application, which is installed on the portable terminal 8. The consumer inputs or selects the company that issues the point card, which is the registration target. Next, the consumer inputs the company member code of the point card, which is the registration target, confirms the number, subsequently presses the registration button, and the registration content is transmitted to the electronic receipt management server 9. Furthermore, the company member code may be input using manual input, camera photography, magnetic reading and the like.

(2) The electronic receipt management server 9 receives the registration content from the portable terminal 8 in (1), matches the registration content with the customer information of each company, and replies to the portable terminal 8 of the consumer with a confirmation display screen.

(3) The consumer confirms the confirmation display screen that is returned from the electronic receipt management server 9, and the association of the member code of the electronic receipt system and the existing company member card is completed by pushing the agreement button.

According to the above description, the service and the point addition service in the electronic receipt system are managed using a unique member code of the electronic receipt system. Therefore, it is possible to receive a loyalty program service in the electronic receipt system by presenting a point card in a store for which a point card of the related art is owned, and by presenting the portable terminal 8 in a store for which a point card is not owned. As a result, it is possible for the electronic receipt system to act as a hub, which relates associates the member code of the electronic receipt with each company member card of each company.

Hereinafter, description will be given of the configuration of each component that constitutes the electronic receipt system of the embodiment.

First, description will be given of the configuration of the components of the portable terminal 8, which is an information processing device, using the block diagram of FIG. 2. As shown in FIG. 2, the portable terminal 8 includes a central processing unit (CPU) 11, memory 12, a storage unit 13, a network interface 14, a display unit 17, an input unit 18, a clock unit 19 and the like. The CPU 11 functions as the control unit, the memory 12 temporarily stores data, the storage unit 13 is readable and writable by commands from the CPU 11 and stores programs, data and the like, the network interface 14 is connected to various public networks including the network 5, the display unit 17 is capable of displaying various information, the input unit 18 operates the portable terminal 8, and the clock unit 19 measures time. The input unit 18 is a touch panel laminated onto the display unit 17, or a key provided on a housing.

In addition to a web browser for viewing various information (content) published on the web, an electronic receipt handling program P11, an electronic receipt viewing program P12 and an additional information viewing program P12a are pre-installed on the storage unit 13. The electronic receipt handling program P11 receives the electronic receipt information, which is generated after a payment according to the product sales data processing, from the electronic receipt management server 9. The electronic receipt viewing program P12 views the received electronic receipt information. The additional information viewing program P12a views the additional information, which is added to the electronic receipt information. Furthermore, the additional information viewing program P12a may also be a portion of the electronic receipt viewing program P12.

In addition, a statistical information generation program P13 is pre-installed on the storage unit 13. The statistical information generation program P13 collects the electronic receipt information, which is received from the electronic receipt server 6 of each company which is described later herein, and generates statistical information based on the company code and the business type or business category code from which a purchase was made.

Furthermore, a receipt information assignment program P14 for breaking out electronic receipt information and assigning portions of the electronic receipt information to another person is pre-installed on the storage unit 13.

The electronic receipt handling program P11, the electronic receipt viewing program P12, the statistical information generation program P13 and the receipt information assignment program P14, which are executed by the portable terminal 8, are provided thereto as a file of an installable format or an executable format by being recorded to a recording medium, which is readable to a computer, such as a CD-ROM, a flexible disk (FD), a CD-R, or a digital versatile disk (DVD).

In addition, a configuration may also be adopted in which the electronic receipt handling program P11, the electronic receipt viewing program P12, the statistical information generation program P13 and the receipt information assignment program P14, which are executed by the portable terminal 8, are provided thereto by being stored on a computer that is connected to a network such as the Internet and downloaded via the network. In addition, a configuration may also be adopted in which the electronic receipt handling program P11, the electronic receipt viewing program P12, the statistical information generation program P13 and the receipt information assignment program P14, which are executed by the portable terminal 8, are provided or distributed thereto via a network such as the Internet.

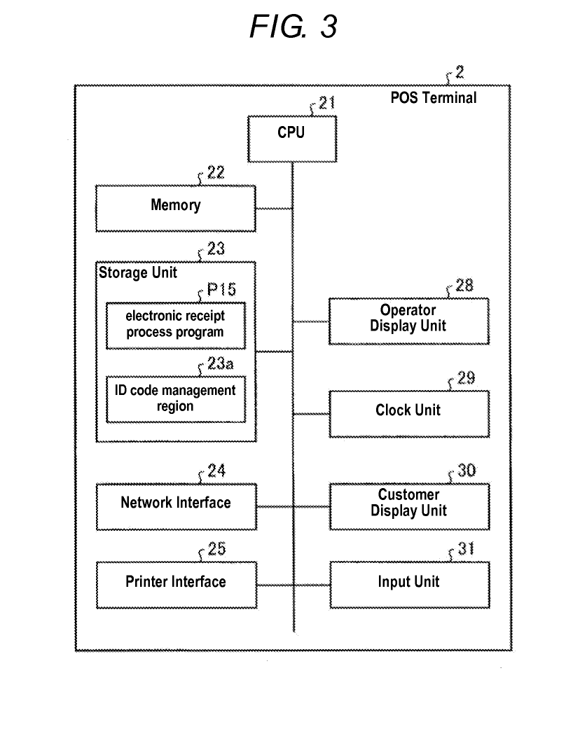

Next, description will be given of the configuration of the components of the POS terminal 2, which is a product sales data processing device, using the block diagram of FIG. 3. As shown in FIG. 3, the POS terminal 2 includes a central processing unit (CPU) 21, memory 22, a storage unit 23, a network interface 24, a printer interface 25, an operator display unit 28, a clock unit 29, a customer display unit 30, an input unit 31 and the like. The CPU 21 functions as the control unit, the memory 22 temporarily stores data, the storage unit 23 is readable and writable by commands from the CPU 21 and stores programs, data and the like, the network interface 24 is connected to the in-store LAN 4, the printer interface 25 is connected to a printer, the operator display unit 28 displays various information to the operator, the clock unit 19 measures time, the customer display unit 30 displays various information to the customer, and the input unit 31 operates the POS terminal 2.

An identification code management region 23a is secured in the storage unit 23 as a region for pre-storing, in addition to a POS number of the POS terminal 2, the company code (an identification code of the company which administers the store), the business type or business category code, the store code, which indicates the store 1 in which the POS terminal 2 is installed, and the like. Here, the business type or business category code is a code (a classification code) which distinguishes the business type or company category of the store as, for example, a convenience store, a supermarket, a department store, a drugstore, a restaurant, a catering establishment or the like. Furthermore, the business type or company category may be changed arbitrarily according to the preference of the user. Furthermore, the company code (the identification code of the company that administers the store) and the business type or business category code may also be registered in the electronic receipt server 6.

In addition, an additional information management region 23b is pre-stored in the storage unit 23 as a region for storing additional information such as coupons, which are used to lower the purchase amount of products and the like, and lottery tickets of prize draws which the seller (the company) of the product organizes. Here, the additional information is added to the product that the company is selling as a service for sales promotion. The additional information may be embodied such that the additional information itself holds content such as textual information and image information, and may also hold access information such as a URL that links to a home page, which is related to a commericial of the company, or a URL that links to a coupon of the company. In addition, the conditions for adding the additional information may be changed arbitrarily according to the preference of the user. Furthermore, the electronic receipt server 6 may add the additional information to the electronic receipt.

In addition, an electronic receipt processing program P15 is also installed on the storage unit 23 in advance in addition to software for executing various POS work including the product sales data processing. The electronic receipt processing program P15 processes electronic receipt information, which is electronically processed upon performing the product sales data processing instead of a receipt or an addressed receipt, which are issued by printing.

Furthermore, the electronic receipt processing program P15, which is executed by the POS terminal 2, is provided thereto as a file of an installable format or an executable format by being recorded to a recording medium, which is readable to a computer, such as a CD-ROM, a flexible disk (FD), a CD-R, or a digital versatile disk (DVD).

In addition, a configuration may also be adopted in which the electronic receipt processing program P15, which is executed by the POS terminal 2, is provided thereto by being stored on a computer that is connected to a network such as the Internet and downloaded via the network. In addition, a configuration may also be adopted in which the electronic receipt processing program P15, which is executed by the POS terminal 2, is provided or distributed thereto via a network such as the Internet.

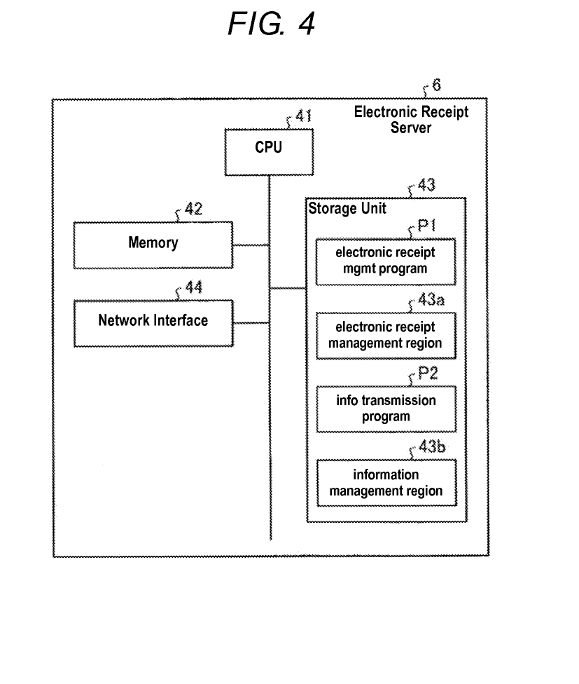

Next, description will be given of the configuration of the components of the electronic receipt server 6, which functions as a corporate receipt management server, using the block diagram of FIG. 4. The electronic receipt server 6 includes a central processing unit (CPU) 41, memory 42, a storage unit 43, a network interface 44 and the like. The CPU 41 functions as the control unit, the memory 42 temporarily stores data, the storage unit 43 is readable and writable by commands from the CPU 41 and stores programs, data and the like, and the network interface 44 is connected to the network 5.

In addition, an electronic receipt management region 43a is secured in the storage unit 43 as a region for storing electronic receipt information for each company that owns or operates a store. The electronic receipt information includes the company code (the identification code of the company that administers the store), the business type or business category code, the store code, the member code of the consumer, the POS number of the POS terminal 2, the receipt number, the product sales data, the additional information and the like. Furthermore, the additional information may also be separately maintained or received with respect to the electronic receipt information, and added (associated) to the electronic receipt information.

In addition, an electronic receipt management program P1 for managing the electronic receipt information, which is received from the POS terminal 2 of each store 1, using the electronic receipt management region 43a is pre-installed on the storage unit 43.

In addition, an information transmission program P2 for transmitting the electronic receipt information, which is managed by the electronic receipt management region 43a, to the electronic receipt management server 9 is pre-installed on the storage unit 43.

Furthermore, an information management region 43b, which stores the various types of additional information that is associated with the desired product, the member, the company and the store, is provided in the storage unit 43. Here, the additional information includes the coupons, lottery tickets and the like described above.

Furthermore, the electronic receipt management program P1 and the information transmission program P2, which are executed by the electronic receipt server 6, are provided thereto as a file of an installable format or an executable format by being recorded to a recording medium, which is readable to a computer, such as a CD-ROM, a flexible disk (FD), a CD-R, or a digital versatile disk (DVD).

In addition, a configuration may also be adopted in which the electronic receipt management program P1 and the information transmission program P2, which are executed by the electronic receipt server 6, may be provided thereto by being stored on a computer that is connected to a network such as the Internet and downloaded via the network. In addition, a configuration may also be adopted in which the electronic receipt management program P1 and the information transmission program P2, which are executed by the electronic receipt server 6, are provided or distributed thereto via a network such as the Internet.

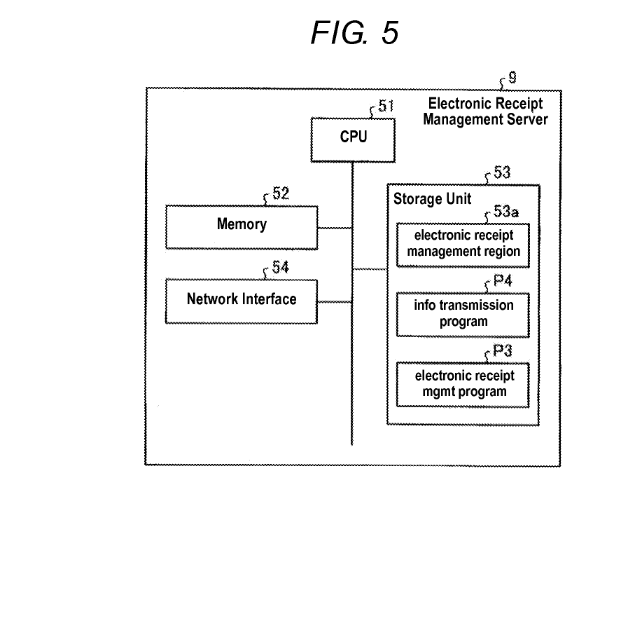

Next, description will be given of the configuration of the components of the electronic receipt management server 9, which functions as a customer receipt management server, using the block diagram of FIG. 5. The electronic receipt management server 9 includes a central processing unit (CPU) 51, memory 52, a storage unit 53, a network interface 54 and the like. The CPU 51 functions as the control unit, the memory 52 temporarily stores data, the storage unit 53 is readable and writable by commands from the CPU 51 and stores programs, data and the like, and the network interface 54 is connected to the network 5.

An electronic receipt management region 53a is secured in the storage unit 53 as a region for storing electronic receipt information of various companies that administer a store collectively. More specifically, the electronic receipt management region 53a manages the electronic receipt information and the additional information of the various companies that administer a store for every member. The electronic receipt information includes the member code, the company code (the identification code of the company that administers the store), the store code, the POS number of the POS terminal 2, the receipt number, the product sales data, the additional information and the like. Furthermore, the additional information may also be maintained or received separately from the electronic receipt information, and added (associated) to the electronic receipt information.

In addition, an electronic receipt management program P3 for managing the additional information and the electronic receipt information, which are received from the electronic receipt server 6 of each company, using the electronic receipt management region 53a is pre-installed on the storage unit 53.

In addition, an information transmission program P4 for transmitting the electronic receipt information and the additional information of the desired product to the portable terminal 8 is pre-installed on the storage unit 53.

Furthermore, the electronic receipt management program P3 and the information transmission program P4, which are executed by the electronic receipt management server 9, are provided thereto as a file of an installable format or an executable format by being recorded to a recording medium, which is readable to a computer, such as a CD-ROM, a flexible disk (FD), a CD-R, or a digital versatile disk (DVD).

In addition, a configuration may also be adopted in which the electronic receipt management program P3 and the information transmission program P4, which are executed by the electronic receipt management server 9, are provided thereto by being stored on a computer that is connected to a network such as the Internet and downloaded via the network. In addition, a configuration may also be adopted in which the electronic receipt management program P3 and the information transmission program P4, which are executed by the electronic receipt management server 9, are provided or distributed thereto via a network such as the Internet.

Next, description will be given of the operations of each component that constitutes the system of the embodiment.

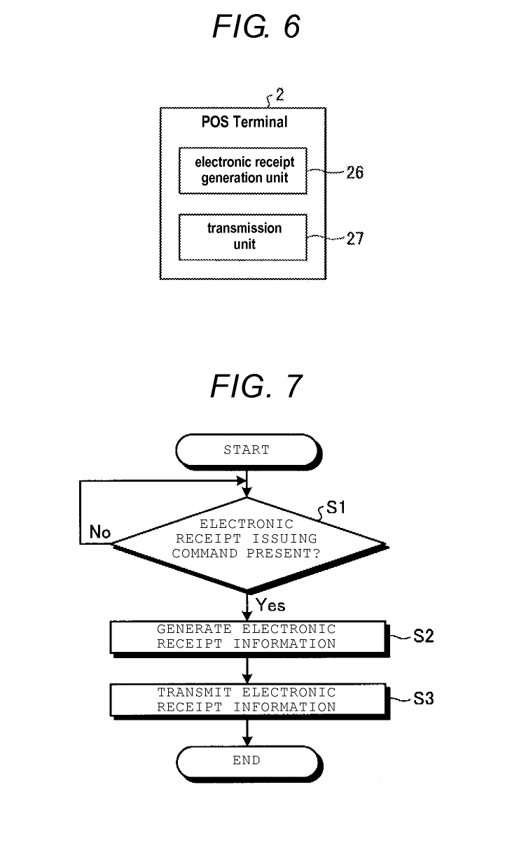

First, description will be given of an electronic receipt process, which is executed by a CPU 21 of the POS terminal 2 operating in accordance with the electronic receipt processing program P15, with reference to the functional block diagram shown in FIG. 6 and the flow chart shown in FIG. 7.

As shown in FIG. 6, the electronic receipt processing program P15 executed by the POS terminal 2 has a modular configuration including an electronic receipt generation unit 26 and a transmission unit 27. In terms of the actual hardware, each component described above is loaded into the memory 22 by the CPU 21 reading out, from the storage unit 23, and executing the electronic receipt processing program P15. Therefore, the electronic receipt generation unit 26 and the transmission unit 27 are generated in the memory 22.

The electronic receipt generation unit 26 associates the electronic receipt information, which includes the company code that indicates the company that owns or operates the store and is electronically processed instead providing a printed product sale, with the member code of the consumer.

The transmission unit 27 transmits the electronic receipt information that is generated by the electronic receipt generation unit 26 to the electronic receipt server 6, which manages the electronic receipt information by company corresponding to company codes.

As shown in FIG. 7, when there is input of a finalizing key or the like, which starts the finalizing process of the product transaction, the CPU 21 (the electronic receipt generation unit 26) of the POS terminal 2 confirms the input of the member code and the presence of electronic receipt issuing capability. The CPU 21 then determines whether or not there is an electronic receipt issuing command, which corresponds to the payment process that corresponds to the finalizing operation (step S1).

In order for the member to indicate the electronic receipt issuing command, a method such as the one shown below may be considered, for example.

1. The clerk operates an “issue electronic receipt” button, which is provided on the input unit 31 (for example, a keyboard) of the POS terminal 2.
2. The consumer, who is the member, displays a bar-code that includes a code on the display unit 17 of the portable terminal 8. The clerk then reads the bar-code using the input unit 31 (for example, a bar-code scanner) of the POS terminal 2.
3. The consumer, who is the member, operates an “issue electronic receipt” button, which is displayed on the customer display unit 30 so as to be possible to press.
4. The consumer, who is the member, displays a bar-code that includes a code on the display unit 17 of the portable terminal 8. The consumer, who is the member, then reads the bar-code using the input unit 31 (for example, a bar-code scanner (preferably a separate scanner from the scanner used for product registration)) of the POS terminal 2 in person.
5. The consumer, who is the member, presents the company member card for receiving the point service, and reads the company member code of the company member card using the input unit 31 (for example, a bar-code scanner, a magnetic card reader, NFC or the like) of the POS terminal 2. When the member code of the electronic receipt is related to the read company member code, an electronic receipt issuing command is determined to be present.

The CPU 21 (the electronic receipt generation unit 26) of the POS terminal 2 waits until an electronic receipt issuing command is present (No in step S1). When the CPU 21 (the electronic receipt generation unit 26) of the POS terminal 2 determines that there is an electronic receipt issuing command (Yes in step S1), the product transaction data is transmitted to the head office server, the CPU 21 generates the electronic receipt information by extracting the company code (the identification code of the company that owns or operates the store), the business type or business category code, the store code, the member code of the consumer, the POS number of the POS terminal 2, the receipt number, the product sales data, the additional information and the like from the identification code management region 23a, the additional information management region 23b or the like, which are provided in the storage unit 23, on the basis of the separately received or maintained product information and the payment information that is registered during the payment according to the product sales data processing (step S2).

Next, the CPU 21 (the transmission unit 27) of the POS terminal 2 connects to the in-store LAN 4 and the network 5 via the network interface 24, transmits the generated electronic receipt information to the electronic receipt server 6 (step S3) and ends the process. Furthermore, when the electronic receipt issuing command is determined not to be present, a paper receipt is issued by printing, the product transaction data is transmitted to the head office server, and the process is ended.

Furthermore, when the CPU 21 of the POS terminal 2 is offline during the transmission of the product transaction data (transaction data) to the head office server, problems are avoided by performing the following information handling sequence.

1. Automatically carry out retry transmission.
2. When step 1 is insufficient to handle the difficulty, the product transaction data (transaction data) is stored until online restoration and is broadcast to the head office server after online restoration. In this case, the CPU 21 of the POS terminal 2 performs display such as “the product transaction data (transaction data) will be transmitted later” on the operator display unit 28.

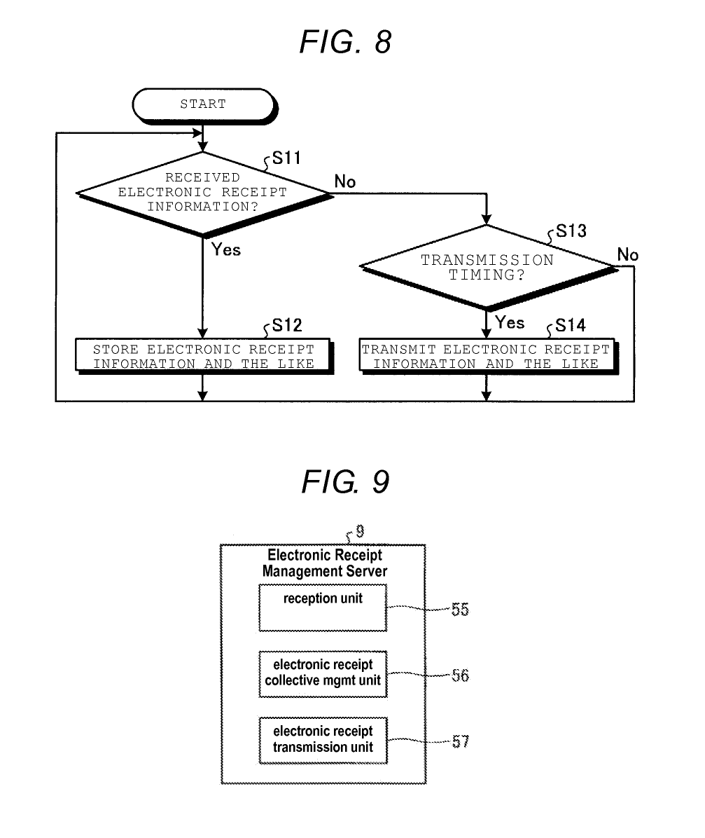

Next, description will be given of the flow of the information transmission process, which is executed by the CPU 41 of the electronic receipt server 6 operating in accordance with the electronic receipt management process and the information transmission program P2, which are executed by operating in accordance with the electronic receipt management program P1, with reference to the flow chart shown in FIG. 8.

When the CPU 41 of the electronic receipt server 6 receives the electronic receipt information, which is transmitted from the POS terminal 2, via the network interface 44 (Yes in step S11), the received information is stored in the electronic receipt management region 43a of the storage unit 43 as electronic receipt information for each company (step S12). In other words, the CPU 41 of the electronic receipt server 6 functions as an electronic receipt management unit, which manages the electronic receipt information in the storage unit 43 maintained by selling company corresponding to the company codes.

In addition, after the CPU 41 of the electronic receipt server 6 stores the received electronic receipt information, when a preset transmission timing is reached (No in step S11 and Yes in step S13), the additional information, which is managed by the information management region 43b, and the electronic receipt information, which is managed by the electronic receipt management region 43a, are transmitted to the electronic receipt management server 9 (step S14), and the process returns to step S11.

Furthermore, in the above description, the CPU 21 (the electronic receipt generation unit 26) of the POS terminal 2 generates the electronic receipt information and transmits the electronic receipt information to the electronic receipt server 6. However, the present disclosure is not limited thereto. For example, the CPU 21 of the POS terminal 2 transmits the store code, the member code of the consumer, the POS number of the POS terminal 2, the receipt number, the product sales data and the like to the electronic receipt server 6 on the basis of the product information and the payment information, which are registered during payment according to the product sales data process. Therefore, the CPU 41 of the electronic receipt server 6 may generate electronic receipt information by adding the company code, the business type or business category code, the additional information or the like to the data transmitted thereto.

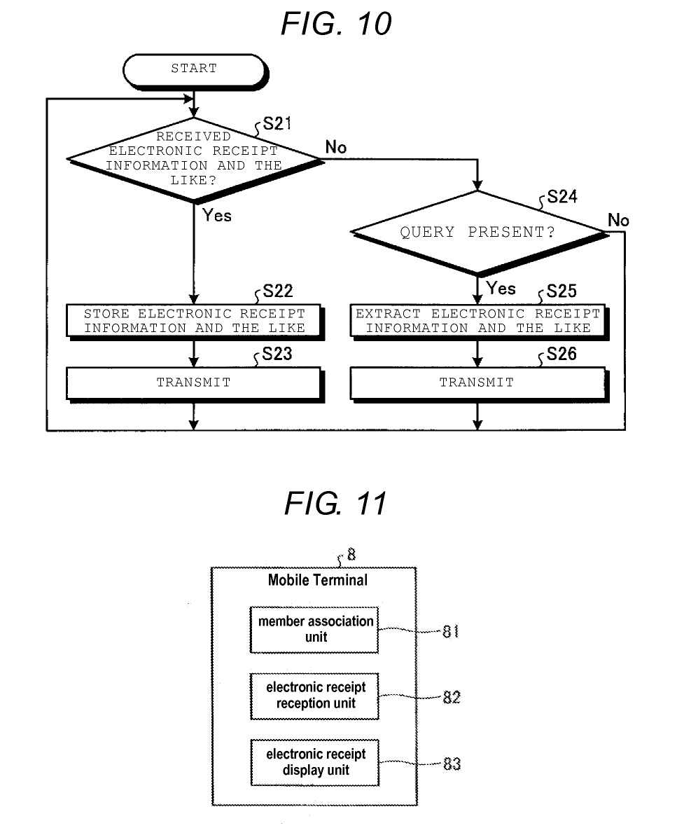

Next, description will be given of the flow of the product information transmission process, which is executed by the CPU 51 of the electronic receipt management server 9 operating in accordance with the electronic receipt management process and the information transmission program P4, which are executed by operating in accordance with the electronic receipt management program P3, with reference to the functional block diagram shown in FIG. 9 and the flow chart shown in FIG. 10.

As shown in FIG. 9, the electronic receipt management program P3 and the information transmission program P4 that are executed by the electronic receipt management server 9 have a modular configuration including a reception unit 55, an electronic receipt batch management unit 56 and an electronic receipt transmission unit 57. Each component described above is loaded into the memory 52 by the CPU 51 reading out, from the storage unit 53, and executing the electronic receipt management program P3 and the information transmission program P4. Therefore, the reception unit 55, the electronic receipt batch management unit 56 and the electronic receipt transmission unit 57 are generated in the memory 52.

The reception unit 55 receives the electronic receipt information broken down by selling company. The electronic receipt information includes the company code that indicates the company that owns or operates the store and is electronically processed instead of a printed the receipt a.

The electronic receipt batch management unit 56 stores the electronic receipt information, which is received using the reception unit 55, broken down by company in the electronic receipt management region 53a of the storage unit 53, and manages the electronic receipt information collectively.

In relation to the portable terminal 8, which is associated with the member code of a designated consumer, the electronic receipt transmission unit 57 acquires the electronic receipt information, which is associated with the member code and includes at least one or more company codes, from the electronic receipt management region 53a and transmits the acquired electronic receipt information.

As shown in FIG. 10, the CPU 51 (the reception unit 55) of the electronic receipt management server 9 determines whether or not the electronic receipt information and the additional information, which are transmitted from the electronic receipt server 6 of each company, have been received via the network interface 54 (step S21).

When the electronic receipt information and the additional information are received (Yes in step S21), the CPU 51 (the electronic receipt batch management unit 56) of the electronic receipt management server 9 stores the electronic receipt information and the additional information of the various companies in the electronic receipt management region 53a of the storage unit 53 collectively (step S22).

In addition, after the CPU 51 (the electronic receipt transmission unit 57) of the electronic receipt management server 9 stores the electronic receipt information and the additional information in the electronic receipt management region 53a collectively, the CPU 51 transmits the electronic receipt information and the additional information to the portable terminal 8 (step S23) and returns to step S21. Furthermore, when the transmission of the electronic receipt information is completed, the transmission results of the electronic receipt information may be managed by storing a flag that signifies the completion of the transmission in relation to the electronic receipt information of the electronic receipt management region 53a.

In addition, when there is a query of the electronic receipt information from the portable terminal 8 (No in step S21 and Yes in step S24), the CPU 51 (the electronic receipt transmission unit 57) of the electronic receipt management server 9 extracts the additional information and the electronic receipt information, which are managed in the electronic receipt management region 53a, according to the content of the query of the electronic receipt information (step S25), subsequently transmits the queried additional information and the electronic receipt information to the portable terminal (step S26) and returns to step S21.

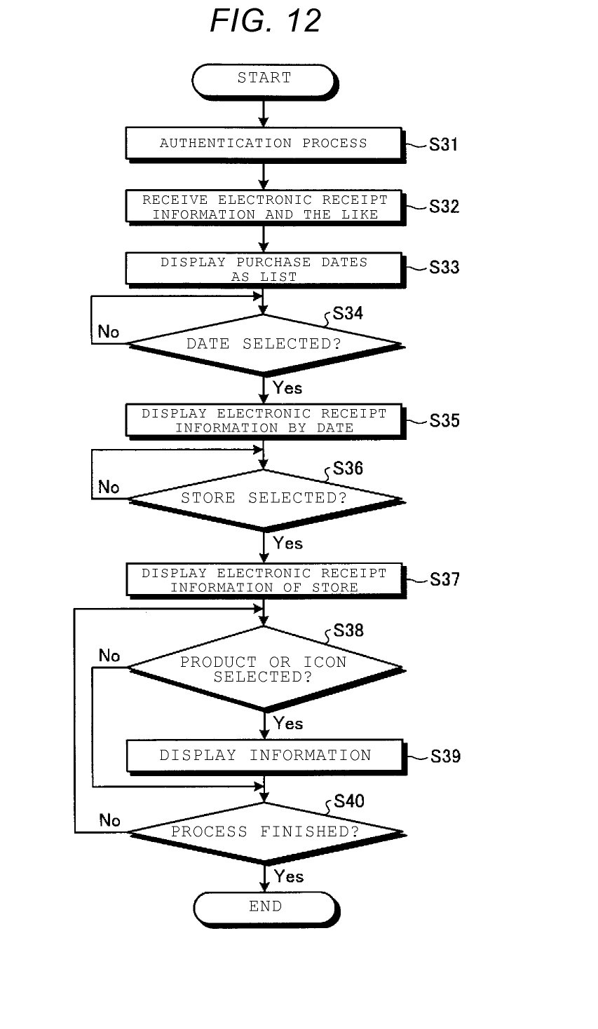

Next, description will be given of the flow of the electronic receipt viewing process, which is executed by the CPU 11 of the portable terminal 8 operating in accordance with the electronic receipt receiving process and the electronic receipt viewing program P12, which are executed by operating in accordance with the electronic receipt handling program P11, with reference to the functional block diagram shown in FIG. 11 and the flow chart shown in FIG. 12.

As shown in FIG. 11, the electronic receipt handling program P11, the electronic receipt viewing program P12 and the additional information viewing program P12a that are executed by the portable terminal 8 have a modular configuration including a member association unit 81, which functions as the member association means, an electronic receipt reception unit 82, which functions as the reception means, and an electronic receipt display unit 83, which functions as the display means. Each component described above is loaded into the memory 12 by the CPU 11 reading out, from the storage unit 13, and executing the electronic receipt handling program P11, the electronic receipt viewing program P12 and the additional information viewing program P12a. Therefore, the member association unit 81, the electronic receipt reception unit 82 and the electronic receipt display unit 83 are generated in the memory 12.

The member association unit 81 associates the member code of a designated consumer with the electronic receipt information.

The electronic receipt reception unit 82 receives (acquires) the electronic receipt information and the additional information, which correspond to the member code that is associated by the member association unit 81, from the electronic receipt management server 9, which manages the electronic receipt information collectively.

The electronic receipt display unit 83 sorts the electronic receipt information and the additional information, which are received by the electronic receipt reception unit 82, sorted by units of company code or the like, and displays the electronic receipt information and the additional information on the display unit 17.

As shown in FIG. 12, first, the CPU 11 (the member association unit 81) of the portable terminal 8 accesses the electronic receipt management server 9 and executes an authentication process using the input of the member code and the password (step S31). Accordingly, the portable terminal 8 and the member code of a designated consumer are associated with one another.

After the authentication, the CPU 11 (the electronic receipt reception unit 82) of the portable terminal 8 receives the electronic receipt information and the additional information, which are managed in the electronic receipt management region 53a corresponding to the input member code (step S32). Furthermore, the reception of the electronic receipt information and the additional information may also be received using electronic mail.

Next, the CPU 11 (the electronic receipt display unit 83) of the portable terminal 8 displays the purchase date included in the electronic receipt information on the display unit 17 as a list (step S33). The portable terminal 8 prompts the user, who is the consumer, to select the information by displaying the purchase date on the display unit 17 as a list in this manner.

When the CPU 11 (the electronic receipt display unit 83) of the portable terminal 8 determines that the store is selected by the user by the desired date (Yes in step S36), the CPU 11 displays the electronic receipt information, which corresponds to the store selected by date, on the display unit (step S37).

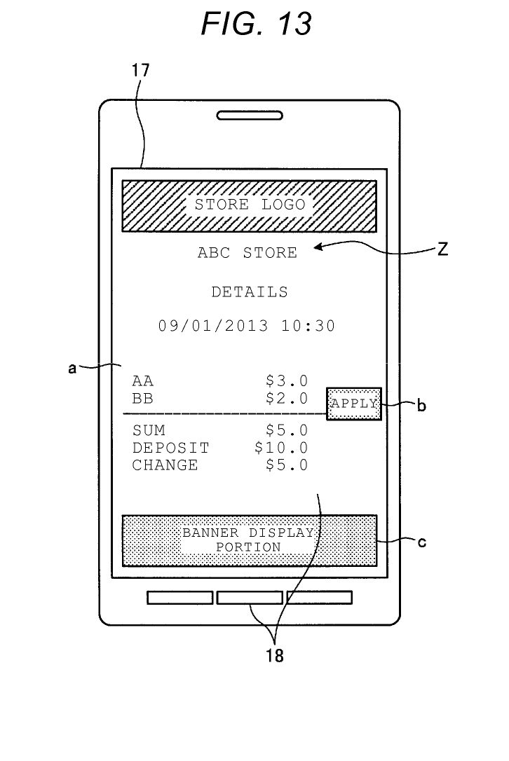

FIG. 13 is a front view showing a display example Z in relation to the display unit 17 of the portable terminal 8. As shown in FIG. 13, the display example Z is a display of the electronic receipt information of a desired store on a desired day on which the user, who owns the portable terminal 8 that accesses the electronic receipt management server 9, went shopping. The display example Z has a similar layout to that of a paper receipt by analyzing the electronic receipt information, and the member's focus may be set to a product a using a cursor which follows the input of the input unit 18 within the display, or the focus may be set to an icon b (in FIG. 13, the button-shaped icon labeled as “apply”), which represents the various additional information that is associated with the product.

Here, when the user selects an appropriate product or an icon, which is associated with the product, (Yes in step S38), the CPU 11 (the electronic receipt display unit 83) of the portable terminal 8 connects to the network 5 via the network interface 14, acquires various information from the network 5 on the basis of the access information, which is related to the selected product or icon, and displays the information on the display unit 17 (step S39).

For example, when, as the access information in relation to the product a, a home page related to the product is set as a product information link, the home page, which is related to the product, is displayed on the display unit 17 when the desired product is selected.

In addition, when a home page related to an application campaign is set as the access information in relation to a button-shaped icon b labeled as “apply”, the application campaign page related to the “apply” button is displayed on the display unit 17 when the “apply” button is selected.

In addition, when a home page related to a CM is set as the access information in relation to a banner c, which is a type of icon, the CM related to the banner c is displayed on the display unit 17 when the banner c is selected.

When the end of the electronic receipt viewing process is declared from an input unit 18 (Yes in step S40), the CPU 11 of the portable terminal 8 ends the process.

When the end of the electronic receipt viewing process is not declared from the input unit 18 (No in step S40), the CPU 11 of the portable terminal 8 returns to step S38 and waits for the selection of a product or an icon that is associated with a product.

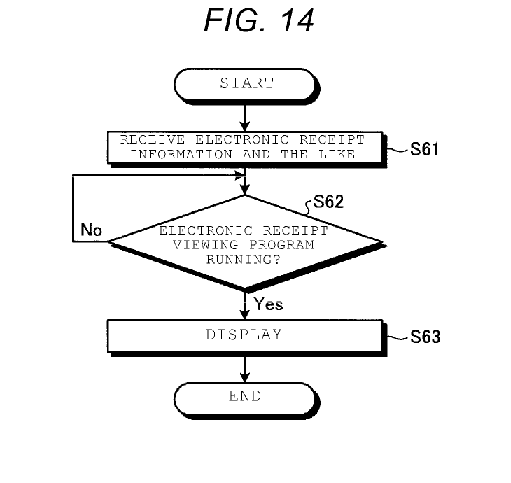

In addition, as described in step S24 of FIG. 10 described above, a case in which, instead of accessing the electronic receipt management server 9 from the portable terminal 8, the portable terminal 8 receives the electronic receipt information and the additional information from the electronic receipt management server 9 is also described with reference to the flow chart of FIG. 14.

The CPU 11 (the electronic receipt reception unit 82) of the portable terminal 8 receives the electronic receipt information and the additional information from the electronic receipt management server 9 (step S61).

Subsequently, when the electronic receipt viewing program P12 is run (Yes in step S62), the CPU 11 (the electronic receipt display unit 83) of the portable terminal 8 relates the received electronic receipt information and additional information with the company code and displays the electronic receipt information and the additional information (step S63).

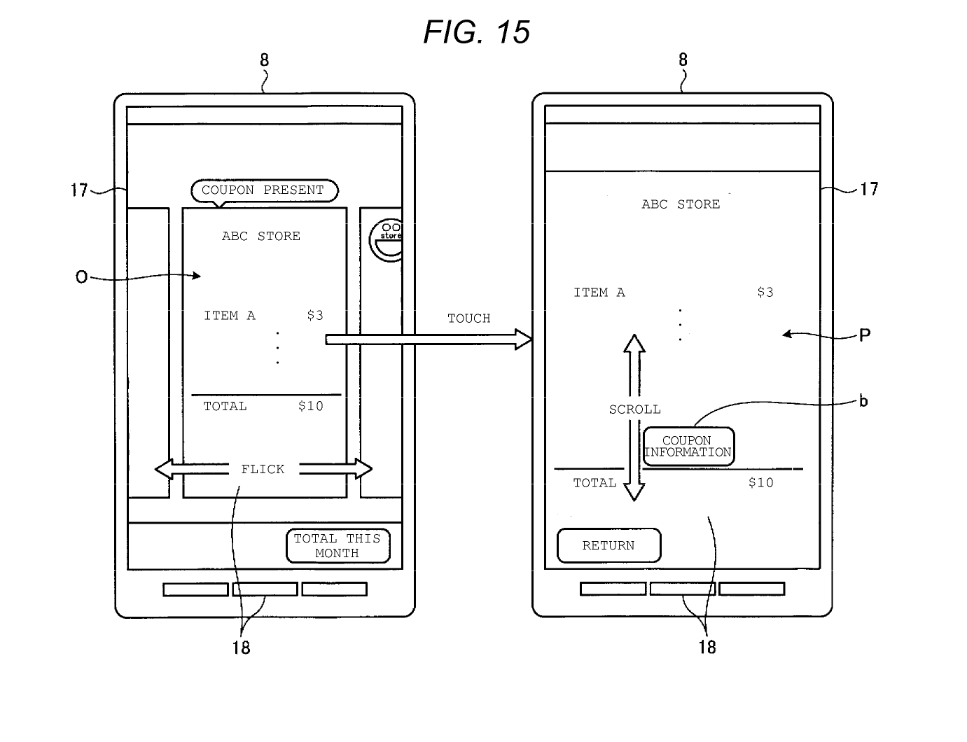

FIG. 15 is a front view showing a display transition example in relation to the display unit 17 of the portable terminal 8. A display example O shown in FIG. 15 sorts the electronic receipt information by company code, in the order received from the electronic receipt management server 9, and displays the electronic receipt information. In the display example O shown in FIG. 15, one item of electronic receipt information may be selected using a flick operation (the sliding of a finger to the left or right) or touch in relation to the input unit 18 (a touch panel laminated onto the display unit 17). In addition, as shown in the display example O shown in FIG. 15, a message “coupon present” is displayed as the additional information on the electronic receipt to which a coupon was added.

When one item of electronic receipt information is selected, as shown in a display example P shown in the left side of FIG. 15, the selected electronic receipt information is displayed on the display unit 17 of the portable terminal 8. The display example P has a similar layout to that of a paper receipt by analyzing the electronic receipt information, and it is possible to scroll in relation to the input unit 18 (a touch panel laminated onto the display unit 17) within the display. In addition, operation in relation to the icon b (the button-shaped icon labeled as “coupon information” in FIG. 15), which represents various additional information associated with the product, may be performed via the input unit 18 (a touch panel laminated onto the display unit 17).

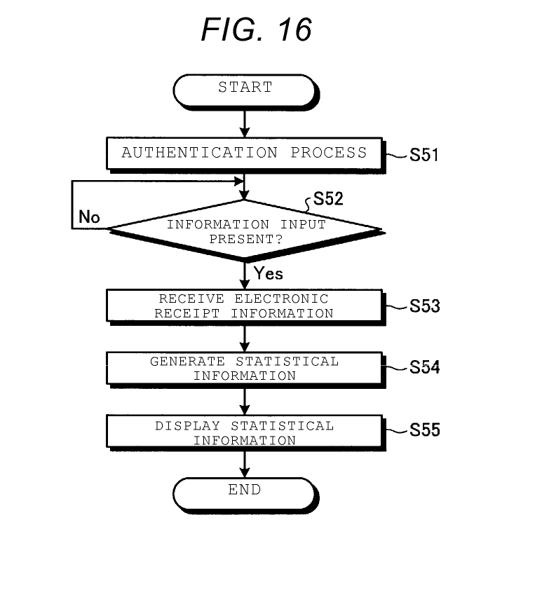

First, description will be given of the flow of the statistical information generation process, which is executed by the CPU 11 of the portable terminal 8 operating in accordance with the statistical information generation program P13, with reference to the flow chart shown in FIG. 16.

The CPU 11 of the portable terminal 8 accesses the electronic receipt management server 9 and executes the authentication process using the input of the member code and the password (step S51).

After the authentication, when the CPU 11 of the portable terminal 8 determines that the input of the information necessary to generate the statistical information, such as the period for which to generate the statistical information and the type of the statistical information, is present (Yes in step S52), the CPU 11 receives the electronic receipt information, which is managed in the electronic receipt management region 53a corresponding to the input member code and the information necessary to generate the statistical information (step S53).

Next, the CPU 11 of the portable terminal 8 generates the statistical information that is statistically collected (sorted or categorized) on the basis of the information (for example, the company code or the business type or business category code) necessary to generate the statistical information from the acquired electronic receipt information (step S54), and displays the generated statistical information on the display unit 17 (step S55).

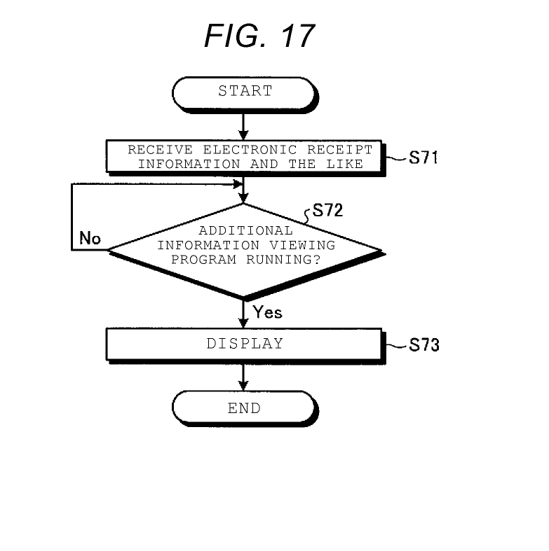

Next, description will be given of the flow of the additional information viewing process, which is executed by the CPU 11 of the portable terminal 8 operating in accordance with the electronic receipt receiving process and the additional information viewing program P12a, which are executed by operating in accordance with the electronic receipt handling program P11, with reference to the flow chart shown in FIG. 17. Furthermore, the process may also be executed as a portion of the electronic receipt viewing process described above.

As shown in FIG. 17, the CPU 11 (the electronic receipt reception unit 82) of the portable terminal 8 receives the electronic receipt information and the additional information from the electronic receipt management server 9 (step S71).

Subsequently, when the additional information viewing program P12a is run (Yes in step S72), the CPU 11 (the electronic receipt display unit 83) of the portable terminal 8 associates the received additional information with the company code and displays the additional information (step S73).

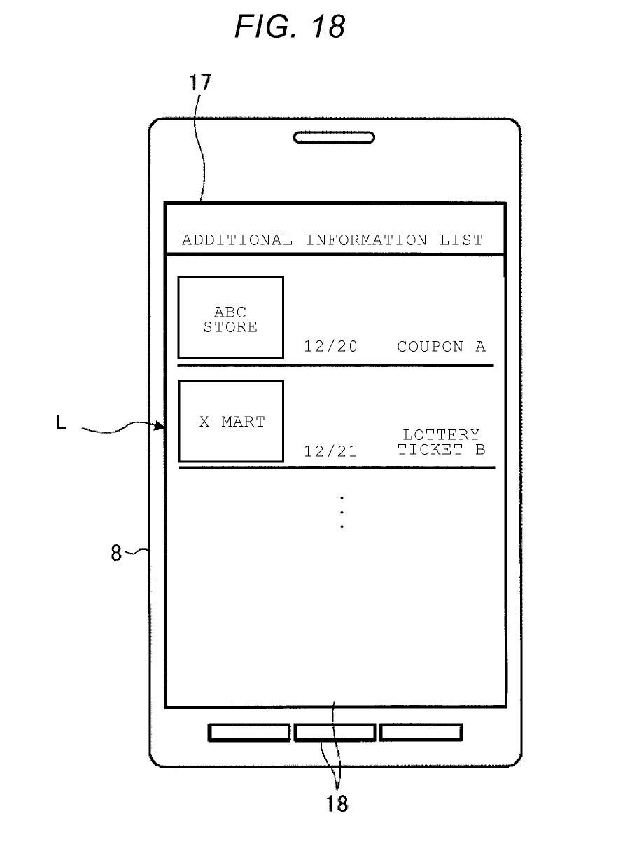

FIG. 18 is a front view showing a display example in relation to the display unit 17 of the portable terminal 8. A display example L shown in FIG. 18 sorts the additional information in the order received from the electronic receipt management server 9, and displays the additional information. In FIG. 18, an example is shown in which “coupon A” or the like is displayed as the type of the additional information. However, even with other additional information, a textual string or the like indicating the type thereof is displayed.

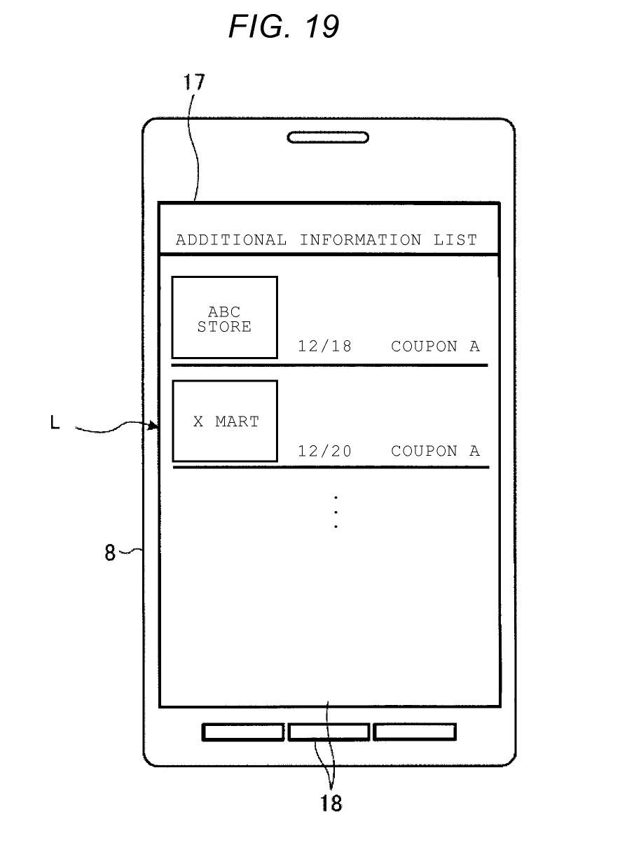

In the display example L of FIG. 18, when the company trademark displayed on the display unit 17 is selected by a touch operation, the CPU 11 (the electronic receipt display unit 83) of the portable terminal 8 sorts the additional information added to the store of the company that is touched in the time series order in which electronic receipts including the additional information are issued (generated), and the CPU 11 displays the additional information as a list (refer to FIG. 19). By displaying information relating only to the stores of companies with a high usage frequency by the customer on the list, the additional information added to the stores is easy to understand. Furthermore, the element used as the sorting reference is not limited to the examples described above. For example, the sorting may also be performed by the type of the additional information, by the various elements relating to the additional information and the like.

In addition, in the display example L of FIG. 18 (or FIG. 19), when the additional information (a coupon or a lottery ticket) displayed on the display unit 17 is selected by a touch operation, the CPU 11 (the electronic receipt display unit 83) of the portable terminal 8 performs detailed display relating to the additional information. Here, the method of the detailed display is not particularly an issue. For example, as shown in FIG. 15, the electronic receipt to which additional information is added may also be displayed. In addition, when content such as textual information and image data is held in the additional information itself, the content thereof may also be displayed. In addition, when access information such as a URL is held in the additional information, the link destination indicated by the access information is accessed and the content provided from the link destination may also be displayed.

In this manner, according to the display example L, since detailed display of the additional information may be easily performed, user friendliness may be improved. Furthermore, the display example of the additional information is not limited to the examples described above. For example, an embodiment may also be adopted in which only the additional information is displayed in a list format or the like.

In addition, the electronic receipt information may also be shared between the members of the electronic receipt system. By interrelating a plurality of the member codes, sales data of the products that each individual purchases may be shared with, for example, a family, a group, a department of a company or the like.

In this manner, according to the electronic receipt system of the embodiment, since, unlike the electronic receipt (and the additional information) system dedicated to specific companies of the related art, the electronic receipt system hereof may be implemented to go beyond the company scope, and the acceptance of the electronic receipts may be promoted.

For example, in the embodiment, a configuration is adopted in which the additional information is added to the electronic receipt information in the POS terminal 2 or the electronic receipt server 6. However, the embodiment is not limited thereto, and a configuration may also be adopted in which the additional information is added in the electronic receipt management server 9. Hereinafter, such an embodiment is described as a modification example of the embodiment described above.

### Modification Example

In the modification example, description will be given using a campaign (an event) such as a lottery, which is performed in a shopping center having a plurality of stores 1. Furthermore, in the modification example, the storage unit 53 of the electronic receipt management server 9 associates the store codes of each store 1, which comprise the shopping center, and stores and manages the event information relating to the events as the additional information. Here, the event information includes, for example, an event ID for identifying each event, the conditions relating to participation (application) in the events and the like.

In addition, in the modification example, the storage unit 53 of the electronic receipt management server 9 stores and manages application status information relating to the event as the additional information and associates the additional information with the electronic receipt information of each company that relates to an event (an event ID), of the electronic receipt information of each user stored and managed in the electronic receipt management region 53a. Here, the application status information includes, for example, a flag of whether or not application is complete, number of times applied (application times) and the like.

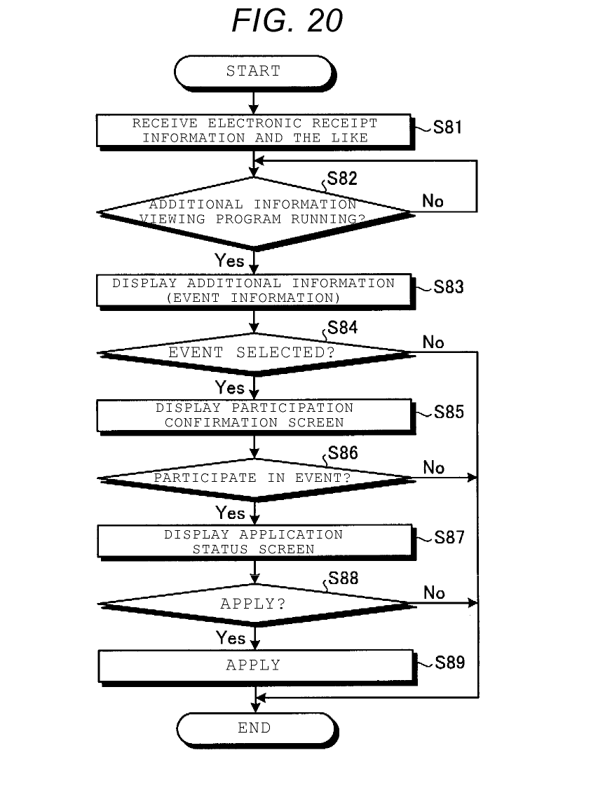

FIG. 20 is a flow chart showing the flow of the electronic receipt receiving process and the additional information viewing process, which are executed by the portable terminal 8, according to the modification example. Furthermore, the process may also be executed as a portion of the electronic receipt viewing process described above.

As shown in FIG. 20, the CPU 11 (the electronic receipt reception unit 82) of the portable terminal 8 receives the electronic receipt information and the additional information (the event information and the application status information) from the electronic receipt management server 9 (step S81).

Here, the CPU 51 of the electronic receipt management server 9 transmits the event information, which is associated with the store code of the electronic receipt information on the basis of the electronic receipt information including the member code of the portable terminal 8, to the portable terminal 8 as the additional information. Here, the CPU 51 of the electronic receipt management server 9 transmits the application status information, which is associated with the electronic receipt information of the transmission target, to the portable terminal 8 as the additional information.

Furthermore, the transmitting and receiving of the event information is not limited to being performed during transmitting and receiving of the electronic receipt information. For example, in the portable terminal 8, the event information relating to the events being carried out in the shopping center may be acquired by specifying the location or the like of the shopping center. Here, the designation of the location or the like may also be performed manually via the input unit 18. In addition, when the portable terminal 8 includes a GPS function or the like, which is capable of acquiring the positional information of the device itself, the location may also be designated using the positional information of the shopping center that is acquired using the function.

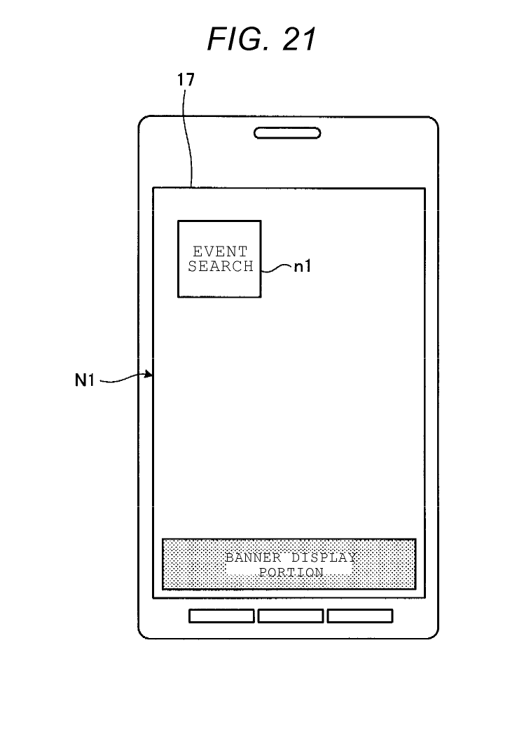

When the GPS function or the like is used, the CPU 11 of the portable terminal 8, as shown in a display example N1 of FIG. 21, for example, may also be configured such that a button n1, which commands the searching of an event, is displayed and the positional information is input according to the operation of the button n1. In addition, when such an embodiment is adopted, the electronic receipt management server 9 holds an address specification table, which may specify the address (the shopping center or the like) of the store 1 from the store code of each store 1. Furthermore, the CPU 51 of the electronic receipt management server 9 specifies the shopping center that corresponds to the command information received from the portable terminal 8 and transmits the event information, which is associated with the store 1 (the store code) of the shopping center, to the portable terminal 8.

Returning to FIG. 20, when the additional information viewing program P12a is run on the portable terminal 8 (Yes in step S82), the CPU 11 (the electronic receipt display unit 83) of the portable terminal 8 displays the received additional information (the event information) on the display unit 17 (step S83).

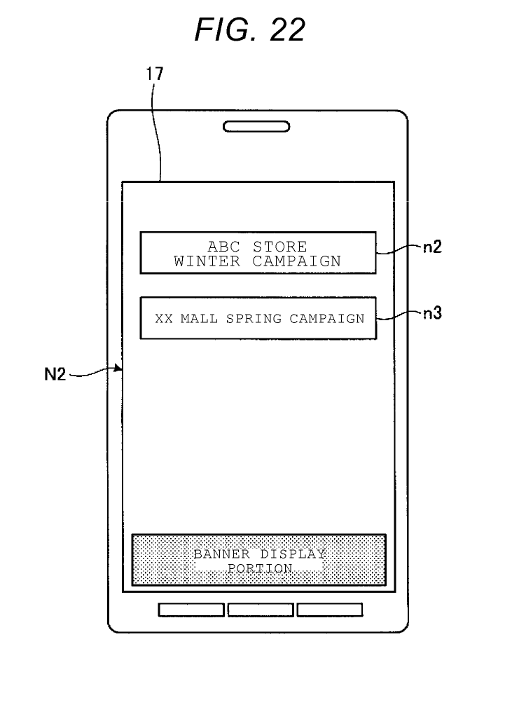

FIG. 22 is a front view showing a display example in relation to the display unit 17 of the portable terminal 8. A display example N2 shown in FIG. 22 displays the event information received from the electronic receipt management server 9. In FIG. 22, an example in which two items of event information n2 and n3 are displayed is shown, and one of the items of event information (events) may be selected.

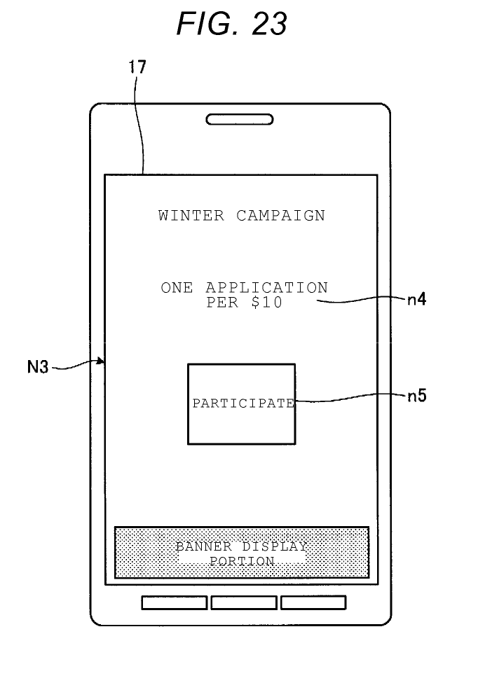

When the CPU 11 of the portable terminal 8 receives the selection of the event (Yes in step S84), as shown in FIG. 23, a participation confirmation screen for confirming participation in the event is displayed on the display unit 17 (step S85). Furthermore, when an event is not selected due to the operation or the like of another button (No in step S84), the process ends.

A display example N3 shown in FIG. 23 is a display example of the case in which the event information n2 of FIG. 22 is selected. In addition, the display example N3 displays condition information n4 included in the event information, and displays a button n5 for requesting participation in the event. In the condition information n4, the condition is that it is possible to apply a one-time US$10 purchase monetary amount (or the sum value of the purchase monetary amounts) at the shopping center.

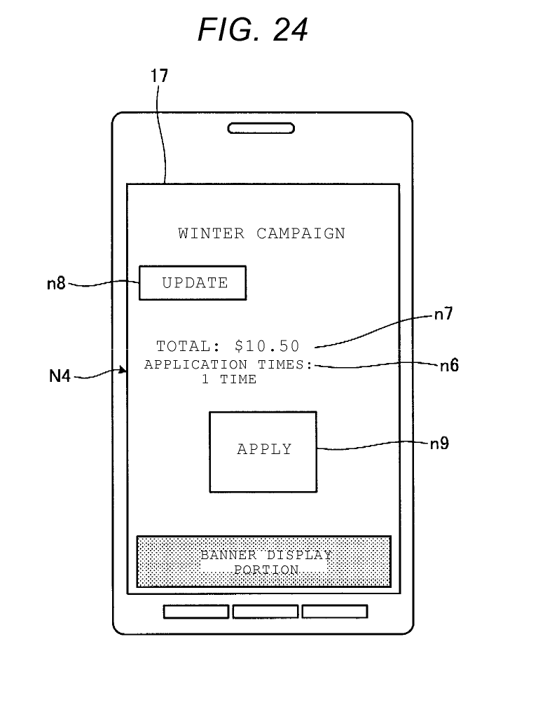

When the CPU 11 (the electronic receipt display unit 83) of the portable terminal 8 receives the participation command to the event according to the operation of the button n5 (Yes in step S86), as shown in FIG. 24, an application status screen, which performs detailed display of the event for which participation is requested, is displayed on the display unit 17 (step S87). Furthermore, when participation in an event is not requested due to the operation or the like of another button (No in step S86), the process ends.

FIG. 24 is a front view showing a display example in relation to the display unit 17 of the portable terminal 8. A display example N4 shown in FIG. 24 displays the application status screen of the event information n2, in which participation is requested in FIG. 23. Here, an application times n6 displays the application times included in the application status information. In addition, the total value of the sales sum values included in the electronic receipt information received in step S81, that is, included in the electronic receipt information issued by each store 1 (shopping center) relating to the event, is displayed as a total n7.

Here, the total n7 may display the total value of the sales sums without change. Alternatively, display control may also be performed such that the total n7 is a value obtained by subtracting the integrated value of the monetary amount (US$10) defined in the condition information and the application times (1 time) from the total value of the sales sum values. When the latter display embodiment is adopted, since the monetary amount that may be used for applying to the event may be directly checked, the user-friendliness may be improved.

In addition, as shown in FIG. 24, the application status screen includes a button n8 for commanding the re-acquisition of the additional information. When the CPU 11 of the portable terminal 8 receives the operation of the button n8, the electronic receipt management server 9 is commanded to perform re-acquisition of the application status information by transmitting the event ID of the event which the customer asked to participate in and the member code to the electronic receipt management server 9. In this case, the CPU 51 of the electronic receipt management server 9 reads out the electronic receipt information and the application status information, which correspond to a combination of the event ID and the member code received from the portable terminal 8, from the storage unit 53 and transmits the electronic receipt information and the application status information to the portable terminal 8. Furthermore, the CPU 11 of the portable terminal 8 updates and displays the application status screen described above on the basis of the received electronic receipt information and application status information. Accordingly, for example, when new electronic receipt information relating to an event is added to the electronic receipt management server 9, the sales sum monetary amount of the electronic receipt information is reflected in the total n7 of the application status screen.

In addition, as shown in FIG. 24, the application status screen includes a button n9 for requesting an application to attend an event. When the CPU 11 of the portable terminal 8 receives the operation of the button n9 (Yes in step S88), an application to attend the event is performed by transmitting the application information, which includes the event ID of the event and the member code, to the electronic receipt management server 9 (step S89), and the process ends. In addition, when application to an event is not requested due to the operation or the like of another button (No in step S88), the process ends. Furthermore, when the value of the total n7 does not fulfill the usage conditions (for example, US$10), the CPU 11 of the portable terminal 8 may prevent the button n9 from being unintentionally operated by disabling the button n9.

Meanwhile, when the CPU 51 of the electronic receipt management server 9 receives the application information from the portable terminal 8, the CPU 51 increments by 1 the application times in the application status information, which is specified by the application information (the event ID and the member code), and completes the application reception. In addition, each time the CPU 51 of the electronic receipt management server 9 receives new electronic receipt information (and additional information) from the electronic receipt server 6, the CPU 51 determines whether or not the combination of the store code and the member code, which are included in the electronic receipt information, corresponds to the management target of the application status information. Furthermore, when the combination corresponds to the management target, the CPU 51 associates and manages the received electronic receipt and the application status information.

Furthermore, when display control of the total n7 is not performed in the portable terminal 8 to subtract a monetary amount according to the application times, the CPU 51 of the electronic receipt management server 9 may perform control such that a monetary amount according to the application times is subtracted from the total value of the sales sum values in the electronic receipt information that is concerned. For the control, for example, command information, which commands that a monetary amount according to the application times be subtracted from the total value of the sales sum values in the electronic receipt information, may also be added to the additional information and transmitted.

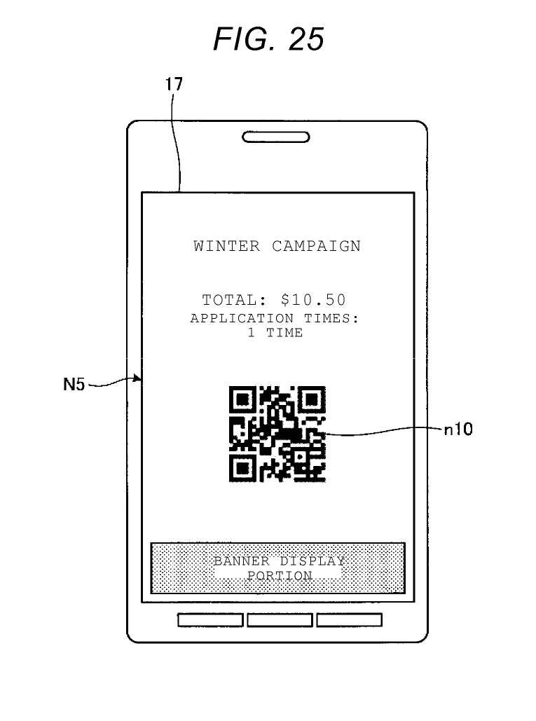

In addition, an embodiment may also be adopted in which the member code or the like is transmitted to an external site relating to the event from the electronic receipt management server 9 in accordance with the completion of the application reception. In addition, when a lottery or the like is performed within a shopping center, application completion information (for example, a two-dimensional bar-code or the like) indicating that the application reception is complete may also be transmitted to the portable terminal 8. In this case, for example, as shown in a display example N5 of FIG. 25, the CPU 11 of the portable terminal 8 displays the application completion information (a two-dimensional code n10), which is transmitted from the electronic receipt management server 9, on the display unit 17. Accordingly, at the administration side of the event, application history to the event may be easily confirmed by reading the two-dimensional code n10, which is displayed on the display unit 17, using a code scanner.

In this manner, according to the electronic receipt system of the modification example, since, unlike the electronic receipt (and the additional information) system sent by or dedicated to individual companies of the related art, the electronic receipt system may be implemented to go beyond the company scope, the introduction of the electronic receipts may be promoted.

In addition, as in the modification example described above, since the additional information may be provided and received in units of an aggregate body such as a shopping center including a plurality of the stores 1, the introduction of the electronic receipts may be promoted, and sales may be promoted, in units of the aggregate body. In addition, in the modification example described above, since a fractional portion of the sales sum values, the individual payments of which do not satisfy the application conditions, may be effectively used by inheriting the payment content (the sales sum values) in each store 1 as the total value, the user-friendliness may be improved.

Furthermore, in the modification example described above, an embodiment is adopted in which the CPU 11 of the portable terminal 8 performs the calculation of the total value and the like. However, the embodiment is not limited thereto, and the CPU 51 of the electronic receipt management server 9 may also calculate the total value and the like. In addition, an embodiment may also be adopted in which the screen configuration of the participation confirmation screen and the like is provided to the portable terminal 8 by the electronic receipt management server 9.

In addition, in the modification example described above, description is given using the shopping center as an example. However, the embodiment is not limited thereto and an aggregate body such as a shopping district may also be the target. In addition, in the modification example described above, an embodiment is adopted in which the application is performed in two stages of the participation and the application with respect to the event. However, the present disclosure is not limited to the embodiment, and the application status confirmation screen of FIG. 24 may also be displayed after selecting the event (the event information) in FIG. 21.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a member association unit configured to maintain a code of a consumer;
a reception unit configured to receive electronic receipt information and additional information corresponding to the code maintained by the member association unit from an electronic receipt management server which associates the code of each consumer with the electronic receipt information and other information collected for a plurality of companies, the electronic receipt information including information concerning payments made by the consumer to each of the plurality of companies, and the additional information added to the electronic receipt information; and
a display unit configured to display the electronic receipt information and the additional information, which are received by the reception unit.

2. The device according to claim 1, wherein
the display unit is configured to perform detailed display in relation to the additional information when specific additional information is selected among the additional information displayed on the display unit.

3. The device according to claim 2, wherein the detailed display information includes a website related to the additional information.

4. The device according to claim 2, wherein the detailed display information includes information concerning an event.

5. The device according to claim 4, wherein the detailed display information is a two-dimensional code used for an admission to the event.

6. The device according to claim 1, wherein the display unit is configured to sort the additional information based on a prescribed element relating to the additional information, and to display the additional information in a list.

7. The device according to claim 6, wherein the prescribed element is a date.

8. The device according to claim 1, wherein
the reception unit is configured to receive the electronic receipt information, which is associated with the code and includes at least one company code, from the electronic receipt management server; and
the display unit is configured to display the additional information received by the reception unit associated with the company code.

9. The device according to claim 1, wherein the display unit is configured to display information that relates a purchase with a store at which the purchase occurred.

10. A non-transitory computer readable medium comprising a program which causes a computer to carry out a method that includes the steps of:
maintaining a code of a consumer;
receiving electronic receipt information and additional information corresponding to the code from an electronic receipt management server which associates the code of each consumer with the electronic receipt information and other information collected for a plurality of companies, the electronic receipt information including information concerning payments made by the consumer to each of the plurality of companies, and additional information added to the electronic receipt information; and
displaying the electronic receipt information and the additional information.

11. The non-transitory computer readable medium comprising of claim 10, wherein the method further includes the step of:
displaying detailed information concerning the additional information when specific additional information is prompted.

12. The non-transitory computer readable medium comprising of claim 11, wherein the detailed display information includes a website related to the additional information.

13. The non-transitory computer readable medium comprising of claim 12, wherein the detailed display information includes information concerning an event.

14. The non-transitory computer readable medium comprising of claim 13, wherein the detailed display information is a two-dimensional code used for an admission to the event.

15. The non-transitory computer readable medium comprising according to claim 10, wherein the additional information is displayed in a list.

16. The non-transitory computer readable medium comprising of claim 10, wherein
the electronic receipt information includes at least one company code; and
the additional information that is displayed is associated with the company code.

17. The non-transitory computer readable medium comprising of claim 10, wherein the method further includes the step of:
displaying information that relates a purchase with a store at which the purchase occurred.

18. An electronic receipt system, comprising:
an electronic receipt management server configured to manage codes of consumers and associate the code of each consumer with the electronic receipt information and other information collected for a plurality of companies, the electronic receipt information including information concerning payments made by the consumers to each of the plurality of companies and additional information; and
a client device including a member association unit configured to maintain a code associated with the client device, an acquisition unit configured to acquire the electronic receipt information and the additional information corresponding to the code associated with the client device from the electronic receipt management server, and an output unit configured to output the electronic receipt information and the additional information acquired by the acquisition unit.

19. The electronic receipt system of claim 18, wherein the output unit is a display screen.

20. The electronic receipt system of claim 18, wherein the additional information relates to a promotion of a store from which a consumer identified by the code associated with the client device previously purchased a good or service.
